(19) United States
(12) Patent Application Publication
(10) Pub. No.: US 2008/0179812 A1
(43) Pub. Date: Jul. 31, 2008

(54) INKJET IMAGE FORMING APPARATUS AND METHOD TO CONTROL THE SAME

(75) Inventor: In Su Hwamg, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/017,594

(22) Filed: Jan. 22, 2008

(30) Foreign Application Priority Data
Jan. 29, 2007 (KR) 2007-9007

(51) Int. Cl. B65H 43/00; B41F 13/00

(52) U.S. Cl. 271/3.09; 271/3.16; 271/110; 271/145; 270/1.01

(57) ABSTRACT

An inkjet image forming apparatus and a method to control the same. In the apparatus, a pickup roller picks up a print sheet from a cassette containing print sheets. Drive and Feed rollers convey the print sheet. A conveyor motor rotates the feed roller. A controller controls the speed of the conveyor motor around the time when a change is made to forces in which the drive and feed rollers apply to the print sheet. The print sheet is conveyed at normal speed while it is pinched by nips at both the drive and feed rollers and is conveyed slowly after its trailing end passes through the drive roller. This reduces the creation of white stripes on an image printed on the print sheet, caused by a change in force applied to the print sheet when leaving the drive roller after being pinched by nips of both the drive and feed rollers, thereby improving print quality.

### CROSS-REFERENCE TO RELATED APPLICATIONS

This application claims the benefit of Korean Patent Application No. 2007-0009007, filed on Jan. 29, 2007 in the Korean Intellectual Property Office, the disclosure of which is incorporated herein by reference in its entirety.

### BACKGROUND OF THE INVENTION

1. Field of the Invention

The present general inventive concept relates to an inkjet image forming apparatus and a method to control the same, and more particularly, to an inkjet image forming apparatus and a method to control the same that can improve print quality.

2. Description of the Related Art

A general inkjet image forming apparatus picks up sheets of paper stored in a sheet cassette one by one and then prints on and discharges each sheet of paper outside the apparatus. In the inkjet image forming apparatus, control of a conveyor motor is crucial for print quality since each sheet is conveyed along a conveyance path through a conveyor portion including a variety of rollers that receive rotational power from the conveyor motor.

The inkjet image forming apparatus includes a cassette in which a number of sheets of paper are stored, a paper conveyance unit that picks up and conveys a sheet from the cassette, and a print head that ejects ink droplets to the conveyed sheet to print an image on it.

A paper conveyance unit in a general C-pass type inkjet image forming apparatus includes a pickup roller, a drive roller, and a feed roller which are sequentially arranged along a conveyance path.

The drive and feed rollers convey a sheet of paper picked up by the pickup roller to a print head so that an image is printed on the sheet at the print head.

The sheet of paper is conveyed by the force of only the feed roller when the trailing end of the print sheet has passed through the drive roller after it is conveyed by the force of both the drive and feed rollers.

At the moment when the trailing end of the print sheet exits a nip of the drive roller, an abrupt load change occurs to cause a print position error. Thus, a handoff error occurs at a specific position on the print sheet (for example, a position at a distance of 90 mm from the trailing end) to create a white stripe on the image printed on the print sheet.

The extent of this phenomenon varies depending on the type of the sheet being used for printing. The phenomenon is more serious for photo sheets that are thicker than general sheets of paper.

### SUMMARY OF THE INVENTION

The present general inventive concept provides an image forming apparatus and a method to control the same that can improve print quality by reducing the creation of a white stripe on an image printed on a sheet for printing, the creation being caused by a change in force applied to the sheet when the sheet leaves a drive roller while it is being pinched by both the drive and feed rollers.

Additional aspects and/or advantages of the general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including a pickup roller to pick up a sheet to be printed on from a cassette in which a plurality of print sheets is stacked, first and second rollers to convey the print sheet picked up by the pickup roller, a conveyor motor to rotate the first roller, and a controller to control speed of the conveyor motor around time when a change is made to forces which the first and second rollers apply to the print sheet.

The foregoing and/or other aspects and utilities of the present general inventive concept may also be achieved by providing a method to control an image forming apparatus including first and second rollers to convey a print sheet picked up from a cassette in which a plurality of print sheets is stacked, the method including determining whether the current time is around a time when a change is made forces which the first and second rollers apply to the print sheet, and controlling a speed of a conveyor motor when the current time is around the time when the change is made to the forces which the first and second rollers apply to the print sheet.

The foregoing and/or other aspects and utilities of the present general inventive concept may also be achieved by providing an image forming apparatus comprising: a pickup roller to pick up a recording medium from a cassette in which a plurality of recording media is stacked; first and second conveying units spaced apart by a distance to convey the picked up recording medium along a path; and a controller to control a speed at which the conveying units convey the recording medium at a time when the recording medium is leaving the first conveying unit while passing through the second conveying unit.

The image forming apparatus may also include an encoder to detect the amount of conveyance of the recording medium according to the speed of the conveyance thereof such that the controller determines whether the current time is around the time when the recording medium is leaving the first conveying unit while the recording medium is passing through both the first and second conveying units.

The foregoing and/or other aspects and utilities of the present general inventive concept may also be achieved by providing a method of controlling an image forming apparatus including conveying members to convey a recording medium along a conveying path therein, the method comprising: picking up a recording medium from a cassette in which a plurality of recording media is stacked; conveying the picked up recording medium along a path containing at least two conveying units; and controlling a speed of conveyance of the recording medium at a time when the recording medium is leaving one of the at least two conveying units while passing through another one of the at least two conveying units sequentially downstream thereof.

The controlling of a speed of conveyance of the recording medium may include slowing down the speed of conveyance when the recording medium is exiting one of the at least two conveying units while passing through the another one of the at least two conveying units directly downstream thereof and speeding up the conveyance of the recording medium once a trailing edge of the recording medium has exited the one of the at least two conveying units.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic block diagram of an inkjet image forming apparatus according to an embodiment of the present general inventive concept;

FIG. 2 illustrates the configuration of the inkjet image forming apparatus according to the embodiment of FIG. 1;

FIG. 3 illustrates how a print sheet is conveyed while being pinched by both drive and feed rollers in FIG. 2;

FIG. 4 illustrates how the trailing end of the print sheet leaves the drive roller after it has been conveyed while being pinched by both the drive and feed rollers in FIG. 2;

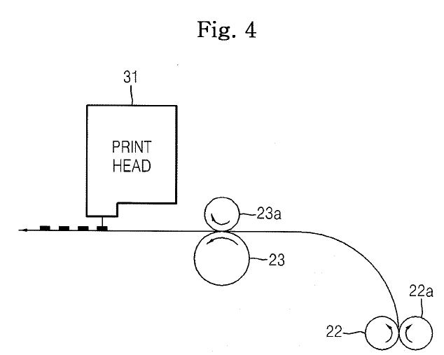

FIG. 5 illustrates how the print sheet is conveyed after the trailing end of the print sheet completely leaves the drive roller in FIG. 2;

FIG. 6 illustrates where a white stripe is created on the print sheet when the print sheet is of A4 size; and

FIG. 7 is a flow chart of a method to control an inkjet image forming apparatus according to an embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

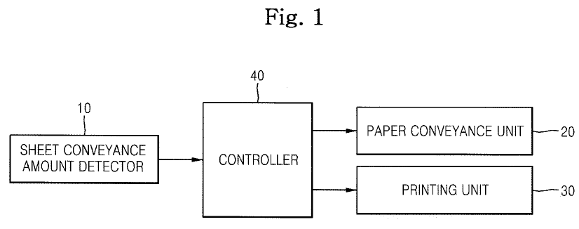

FIG. 1 is a schematic block diagram of an inkjet image forming apparatus according to an embodiment of the present general inventive concept. As illustrated in FIG. 1, the inkjet image forming apparatus according to the present embodiment includes a sheet conveyance amount detector 10, a paper conveyance unit 20, a printing unit 30, and a controller 40. The paper conveyance unit 20 picks up and conveys a sheet of paper or other recording media from a paper storage in which sheets to be printed on (hereinafter referred to as a print sheet) are stacked. The sheet conveyance amount detector 10 detects the amount of the conveyance of the print sheet through the paper conveyance unit 20 (i.e., how far the print sheet has been conveyed). After conveying the print sheet into the paper conveyance unit 20, the controller 40 controls the speed of conveyance of the print sheet at the time when a change is made to forces applied to the print sheet, according to the amount of conveyance of the print sheet detected by the sheet conveyance amount detector 10. The printing unit 30 prints an image on the print sheet under control of the controller 40.

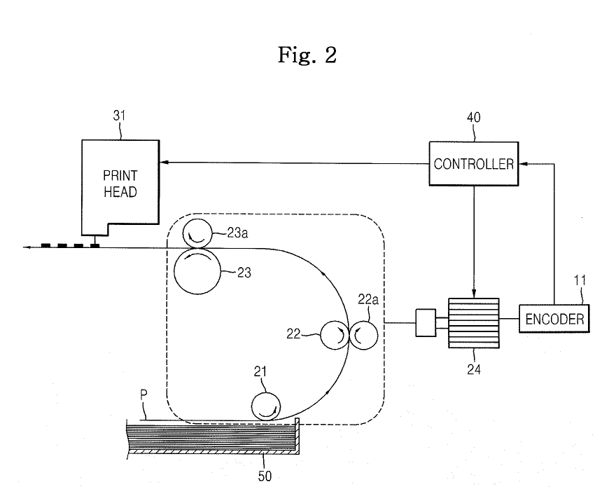

The following is a description of the structures of the above components with reference to FIG. 2. First, the paper storage includes a cassette 50 in which a number of print sheets P are stacked.

The printing unit 30 includes a print head 31 to eject ink droplets to print an image on a print sheet P.

The paper conveyance unit 20 includes a conveyor portion and a driver portion. The conveyor portion can include a pickup roller 21, a drive roller 22, a feed roller 23, and first and second driven rollers 22a and 23a, respectively. It is to be noted that other types of conveying members other than rollers can be used alternatively which convey a recording medium in accordance with the embodiments as described herein. The pickup roller 21 picks up a print sheet P from the cassette 50. The feed roller 23 conveys the print sheet P picked up by the pickup roller 21 at a predetermined speed. The drive roller 22 assists the conveyance of the print sheet P between the pickup roller 21 and the feed roller 23. The first and second driven rollers 22a and 23a rotate while being pressed against the drive and feed rollers 22 and 23, respectively. The driver portion includes a conveyor motor 24 that rotates the pickup roller 21 and the feed roller 23. When the conveyor motor 24 rotates, the pickup roller 21 rotates to pick up a print sheet P from the cassette 50. The pickup roller 21 rotates while being pressed against a print sheet P stored in the cassette 50 only while the pickup roller 21 picks up the print sheet P. When the pickup is completed, the pickup roller 21 is separated from the print sheet P. The conveyor motor 24 also rotates the feed roller 23 as pointed out above. The print sheet P picked up by the pickup roller 21 is conveyed to the feed roller 23 via the drive roller 22.

The sheet conveyance amount detector 10, which is a sheet position detector, includes an encoder to generate a count proportional to the amount of rotation of the feed and pickup rollers 23 and 21 according to the rotation speed of the conveyor motor 24 and to detect a conveyed position of the print sheet P.

The controller 40 causes the print head 31 to eject ink droplets to print an image on the print sheet P when the print sheet P has reached a print position after conveying the print sheet P to the print head 31 through the rollers by rotating the conveyor motor 24.

As described above, a white stripe will be formed on the image due to a change in the force applied to the print sheet P when the print sheet P leaves the drive roller 22 while it is pinched at nips at both the drive and feed rollers 22 and 23. The nips are formed when each of the drive and feed rollers 22 and 23 are in contact with their respective first and second driven rollers 22a and 22b such that the nip is formed between the roller pairs. For example, the drive roller 22 and driven roller 22a form a nip therebetween. More specifically, the image is printed normally on the print sheet P when the print sheet P is pinched at the nips of both the drive and feed rollers 22 and 23. However, at the moment when the trailing end of the print sheet P leaves the drive roller 22 nip, the print sheet P is pinched only by the feed roller 23 nip to cause an abrupt load change. This causes a change in the force applied to the print sheet P to cause a print position error. Thus, the image will be printed abnormally with a white stripe formed thereon.

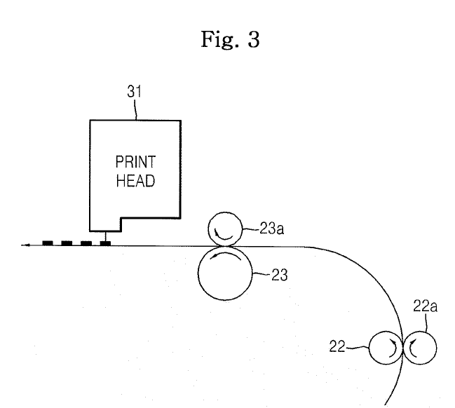

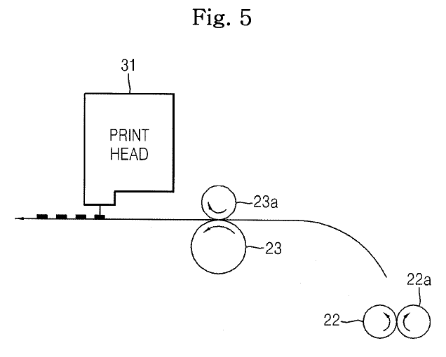

Accordingly, the controller 40 detects the amount of conveyance of the print sheet P through the encoder 11 and rotates the conveyor motor 24 at a normal speed to convey the print sheet P at a normal speed while the print sheet P is pinched by both the nips at the drive and feed rollers 22 and 23 as illustrated in FIG. 3. On the other hand, the controller 40 decreases the speed of the conveyor motor 24 to slowly convey the print sheet P at the time when the trailing end of the print sheet P leaves the nip formed at the drive roller 22 (between the drive roller 22 and the first driven roller 22a). This reduces the abrupt load change when the print sheet P leaves the nip between the drive roller 22 and the first driven roller 22a to be pinched only by the nip between the feed roller 23 and the second driven roller 23a, thereby reducing the creation of a white stripe on the image. After the trailing end of the print sheet P completely leaves the nip between the drive roller 22 and first driven roller 22a, as illustrated in FIG. 5, the controller 40 returns the speed of the conveyor motor 24 to the original speed to convey the print sheet P at a normal speed.

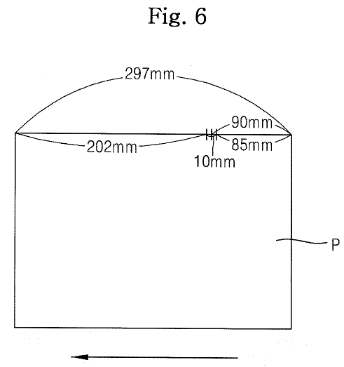

The following is an example where an A4-size print sheet P with a horizontal length of 297 mm is conveyed in arrow direction as illustrated in FIG. 6. In the case where the drive and feed rollers 22 and 23 are spaced 90 mm apart from each other along the conveyance path, a white stripe would be formed on the print sheet P at a position on the print sheet P corresponding to the feed roller 23 when the leading end of the print sheet P has been conveyed 207 mm from the feed roller 23. That is, the white stripe is formed at a position on the print sheet P at a distance of 90 mm from the trailing end of the print sheet P. Thus, it is necessary to convey the print sheet P by a distance as short as possible when the position on the print sheet P is at a distance of 90 mm from the trailing end of the print sheet P. One method to accomplish this is to decrease the conveyance speed of the print sheet P and another is to reduce the unit amount of conveyance of the print sheet P, which is the amount of conveyance (for example, the conveyed print line length) of the print sheet P per operation of the conveyor motor 24, when the position on the print sheet P corresponding to the feed roller 23 is at a distance of 202 mm to 212 (=202+10) mm from the leading end of the print sheet P (i.e., around the time when a change is made to the force that the drive and feed rollers apply to the print sheet).

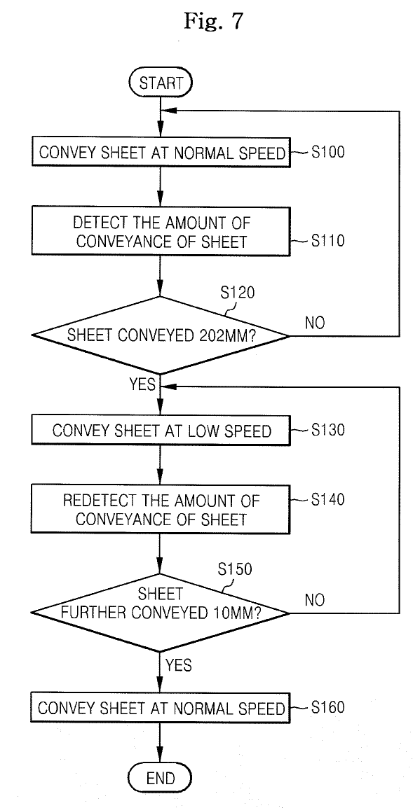

FIG. 7 is a flow chart of a method to control an inkjet image forming apparatus according to an embodiment of the present general inventive concept. As illustrated in FIG. 7, first, the controller 40 drives the conveyor motor 24 to pick up and convey the print sheet P at a normal speed in operation S100. As the conveyor motor 24 rotates, the pickup roller 21 rotates to pick up the print sheet P and the picked-up print sheet P is conveyed toward the print head 31 through the nips at both the drive and feed rollers 22 and 23.

After conveying the print sheet P at a normal speed, the controller 40 detects the amount of conveyance of the print sheet P through the encoder 11 in operation S110. Based on the detected amount of conveyance of the print sheet P, the controller 40 determines, in operation S120, whether the print sheet P has been conveyed a distance of 202 mm. If the print sheet P has not yet been conveyed 202 mm, there is no risk that the trailing end of the print sheet P is leaving the drive roller 22, and thus the controller 40 returns to operation S100 to repeat the above processes.

On the other hand, if the print sheet P has been conveyed a distance of 202 mm, there is a risk that the trailing end of the print sheet P is leaving the drive roller 22 to cause an abrupt load change, and thus the controller 40 decreases the speed of the conveyor motor 24 to slowly convey the print sheet P in operation S130. This reduces the abrupt load change when the trailing end of the print sheet P leaves the drive roller 22, thereby reducing the creation of a white stripe on the image.

Thereafter, the controller 40 repeats detecting the amount of conveyance of the print sheet P through the encoder 11 in operation S140 and determines whether the print sheet P has been further conveyed by 10 mm in operation S150. If the print sheet P has not yet been further conveyed by 10 mm, the controller 40 returns to operation S130 to repeat the subsequent processes.

If the print sheet P has been further conveyed by 10 mm, the controller 40 returns the speed of the conveyor motor 24 to the original speed to convey the print sheet P at a normal speed in operation S160.

As is apparent from the above description, the embodiments of the present general inventive concept provide an inkjet image forming apparatus and a method to control the same wherein a print sheet is conveyed at a normal speed while it is pinched by a nip at both drive and feed rollers and the print sheet is conveyed slowly after its trailing end passes through the nip at the drive roller. This improves print quality by reducing the formation of a white stripe on an image printed on the print sheet, the formation being caused by a change in force applied to the print sheet when the print sheet leaves a drive roller while it is pinched by both a nip at the drive and feed rollers.

Although, in the above embodiments, the determination as to whether the current time is around the time when a change is made to forces at which the feed and drive rollers apply to the print sheet is based on the amount of conveyance of the print sheet, the present general inventive concept is not limited to the determination based on the amount of conveyance and various other methods may be used. One example presets, through experiments, a range of conveyance time of the print sheet corresponding to a time interval around the time when a change is made to forces at which the feed and drive rollers apply to the print sheet.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. An image forming apparatus comprising:
a pickup roller to pick up a print sheet from a cassette in which a plurality of print sheets is stacked;
first and second rollers to convey the print sheet picked up by the pickup roller;
a conveyor motor to rotate the first roller; and
a controller to control a speed of the conveyor motor around a time at which a change is made to forces which the first and second rollers apply to the print sheet.

2. The image forming apparatus according to claim 1, wherein the controller decreases the speed of the conveyor motor around a time when the print sheet is leaving the first roller while the print sheet is pinched by nip regions of both the first and second rollers.

3. The image forming apparatus according to claim 2, further comprising:
an encoder to detect the amount of conveyance of the print sheet according to the speed of the conveyor motor,
wherein, based on the amount of conveyance of the print sheet detected by the encoder, the controller determines whether the current time is around the time when the print sheet leaves the first roller while the print sheet is pinched by both the nip regions of the first and second rollers.

4. The image forming apparatus according to claim 3, wherein the controller decreases the speed of the conveyor motor when the amount of conveyance of the print sheet reaches a preset value.

5. The image forming apparatus according to claim 3, wherein the controller returns the decreased speed of the conveyor motor to the original speed when the print sheet has been conveyed a predetermined distance after decreasing the speed of the conveyor motor.

6. A method to control an image forming apparatus comprising first and second rollers to convey a print sheet picked up from a cassette in which a plurality of print sheets is stacked, the method comprising:
determining whether the current time is around time when a change is made to forces in which the first and second rollers apply to the print sheet; and
controlling speed of a conveyor motor when the current time is around the time when a change is made to the forces in which the first and second rollers apply to the print sheet.

7. The method according to claim 6, wherein the speed of the conveyor motor is decreased around time when the print sheet leaves the first roller while the print sheet is pinched by nip regions of both the first and second rollers.

8. The method according to claim 7, wherein the amount of conveyance of the print sheet is detected according to the speed of the conveyor motor and, based on the detected amount of conveyance of the print sheet, it is determined whether the current time is around the time when the print sheet leaves the first roller while the print sheet is being pinched by the nip regions of both the first and second rollers.

9. The method according to claim 8, wherein the speed of the conveyor motor is decreased when the detected amount of the print sheet reaches a preset value.

10. The method according to claim 8, wherein the decreased speed of the conveyor motor is returned to the original speed when the print sheet has been conveyed a predetermined distance after the speed of the conveyor motor is decreased.

11. An image forming apparatus comprising:
a pickup roller to pick up a recording medium from a cassette in which a plurality of recording media is stacked;
first and second conveying units spaced apart by a distance to convey the picked up recording medium along a path; and
a controller to control a speed at which the conveying units convey the recording medium at a time when the recording medium is leaving the first conveying unit while passing through the second conveying unit.

12. The image forming apparatus according to claim 11, wherein the first and second conveying units are each pairs of rollers forming a nip therebetween.

13. The image forming apparatus according to claim 11, further comprising:
an encoder to detect the amount of conveyance of the recording medium according to the speed of the conveyance thereof such that the controller determines whether the current time is around the time when the recording medium is leaving the first conveying unit while the recording medium is passing through both the first and second conveying units.

14. The image forming apparatus according to claim 13, wherein the controller decreases the speed of the conveyance units when the amount of conveyance of the recording medium reaches a preset value.

15. A method of controlling an image forming apparatus including conveying members to convey a recording medium along a conveying path therein, the method comprising:
picking up a recording medium from a cassette in which a plurality of recording media is stacked;
conveying the picked up recording medium along a path containing at least two conveying units; and
controlling a speed of conveyance of the recording medium at a time when the recording medium is leaving one of the at least two conveying units while passing through another one of the at least two conveying units sequentially downstream thereof.

16. The method according to claim 15, wherein the controlling a speed of conveyance of the recording medium comprises slowing down the speed of conveyance when the recording medium is exiting one of the at least two conveying units while passing through the another one of the at least two conveying units directly downstream thereof and speeding up the conveyance of the recording medium once a trailing edge of the recording medium has exited the one of the at least two conveying units.
